(19) United States
(12) Patent Application Publication
(10) Pub. No.: US 2007/0023516 A1
(43) Pub. Date: Feb. 1, 2007

(54) Intelligent RFID tag and use for improved printing

(76) Inventors: Theodore A. Chapman, San Juan Capistrano, CA (US); Andrew W. Edwards, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/190,306

(22) Filed: Jul. 26, 2005

(51) Int. Cl. G06F 15/12; G06F 17/00; G06K 19/06

(52) U.S. Cl. 235/432; 235/375; 235/492

(57) ABSTRACT

An RFID tag is pre-programmed with information about an object or device used in an RFID printer system. The RFID printer system can then read this information and take the appropriate action, such as user notification or printer parameter adjustment, to improve printer performance. The RFID tag can contain information about and be attached to printer elements, such as an RFID label or roll of labels, a print head, or a printer ribbon.

### BACKGROUND

1. Field of the Invention

The present invention relates to Radio Frequency Identification (RFID) labels and tags, and more particularly to RFID tags that allow more efficient operation of a printer system.

2. Related Art

Typically, products stored in cartons or boxes are identified by a label on the outside of the carton or box. Identifying information may also be printed directly onto the carton with inkjet or any other suitable printing technology. The label may have optically readable information, such as a UPC barcode. These labels allow optical readers using a laser beam to scan the information contained thereon, such as description, price, date packaged, or any other usable data. One disadvantage of optically readable labels is that the optical reader and the label must be within a specific spatial relationship to each other, such as within a line of sight or along a perpendicular scan direction, or is limited in range by the optical reader.

A more recent type of label uses RFID or Radio Frequency Identification tags to store information. RFID uses radio frequency signals to acquire data from RFID tags within range of an RFID reader. RFID transponders or tags, either active or passive, are typically used with the RFID reader to read information from the RFID tag embedded in a label. RFID tags and labels can be obtained through companies, such as Alien Technology Corporation of Morgan Hill, Calif. A typical RFID reader/writer energizes transponder circuitry in the tag by transmitting a power signal. The power signal may convey data which can be stored in a transponder memory, or the transponder circuitry may transmit a response signal containing data previously stored in its memory. If the transponder circuitry transmits a response signal, the RFID reader/writer receives the response signal and interprets the stored data. The data is then transmitted to a host computer for processing.

One advantage of RFID labels is that line of sight is no longer required to read the label. This is a significant advantage since with barcodes, anything blocking the laser beam from the barcode would prevent the barcode from being read. Using radio frequencies allows RFID labels to be read even when line of sight is present between the RFID label and the RFID reader. As the cost and size of RFID tags decrease, more and more companies and groups are favoring or requiring RFID labels on their products.

Even with a growing trend toward RFID labels, there are advantages to placing optical information on a label so that the package has both optical information and RFID, such as having the ability to read the label using more than one technology. This may be beneficial because RFID label technology is not as widespread as barcode technology, and many businesses or users may not have suitable RFID readers to read the RFID tag.

Labels having both RFID and optically readable information can be produced in a printer, such as a thermal printer, by first printing optically readable information on the label and then programming or encoding the RFID tag embedded within the label. Other types of printers may first program the label and then print the information. Still other printers may read the pre-programmed or encoded information from the RFID tag and print the information on the label as optically readable information, such as barcodes. Because there are numerous RFID tag and label manufacturers, such as Alien, it is desirable to have printers that can print optically readable information regardless of the type of RFID tag used in the printer system. However, since each RFID tag or label manufacturer may produce tags having differing compositions, characteristics, sizes, and properties, a single printer system may print tags from different manufacturers differently. For example, the print quality for one type of RFID label may be quite different than for a second type of RFID label.

Accordingly, there is a need for the ability to optimize printing RFID labels of different types.

### SUMMARY

According to one aspect of the invention, RFID tags embedded within thermal printer labels, label cores, ribbons, and print heads include pertinent pre-programmed information, to allow for automatic printer configuration for optimal printer-label performance, and for printer management control.

In one embodiment, pertinent pre-programmed information includes properties and characteristics associated with the RFID label, such as the IC vendor source, the IC vendor lot number and/or date code, the inlay performance level, the inlay antenna type, the label material, the label liner material, the label configuration, and label dimensions. The RFID printer system then reads this information and the printer is configured or acts accordingly. For example, the RF power can be set to an optimal level for a particular antenna type, or the printer can let the operator know that the roll of RFID labels cannot be printed, such as by improper loading or incompatible label type.

In another embodiment, RFID tags are embedded in a ribbon core to increase RFID printer performance. In this embodiment, pertinent pre-programmed information may include the data about the ribbon vendor, ribbon formulation, ribbon date/lot code, and ribbon size. The RFID reader can then process this information to automatically configure the printer, for example, by configuring print head settings and speed to optical levels for the ribbon.

In yet another embodiment, RFID tags are attached to a print head of an RFID printer system. Information contained or pre-programmed in the tag may include the print head vendor, model number, lot/date code, resolution, print width, warranty information, and specific properties of the print head operation. The information may be used by the printer system to configure its operation, such as setting media feeder widths and issuing warnings to the user about upcoming print head servicing or replacement.

This invention will be more fully understood in conjunction with the following detailed description taken together with the following drawings.

### BRIEF DESCRIPTION OF THE DRAWINGS

FIG. 1 shows a block diagram of an exemplary RFID thermal printer system that can be used with the present invention; and

FIG. 2 shows an RFID tag within an RFID label according to one embodiment of the invention.

Use of the same or similar reference numbers in different figures indicates same or like elements.

### DETAILED DESCRIPTION OF THE PREFERRED EMBODIMENTS

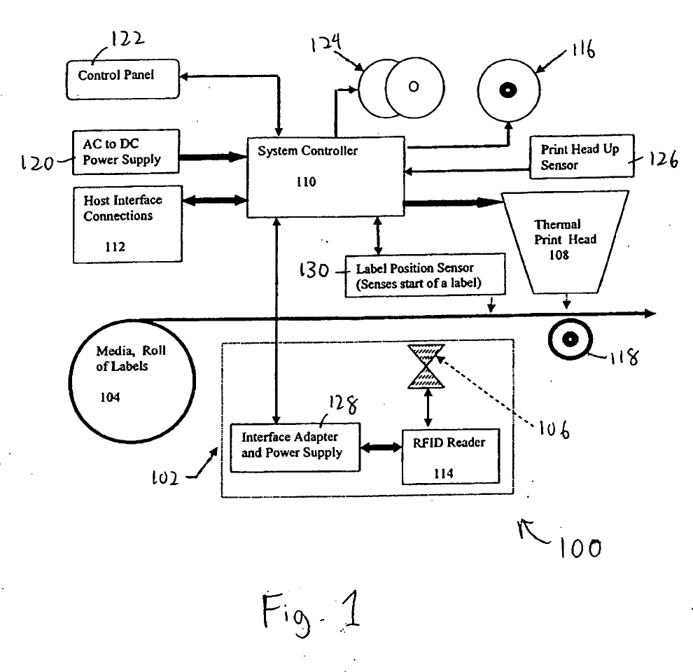

According to one aspect of the present invention, RFID tags are pre-programmed with specific information such that the RFID printer system can read the stored information and use that information to operate the printer system more efficiently. FIG. 1 shows a block diagram of an exemplary printer system 100 with a radio frequency identification (RFID) reader subsystem 102 that may be used with the present invention, although any suitable RFID printer system may be used. Printer system 100 also includes a roll 104 of labels or media, where an RFID tag is embedded in each label. RFID tags are passive or active tags available from a multitude of manufacturers, including Alien Technology Corporation, Matrics, Inc. of Rockville, Md., and Philips Semiconductor of the Netherlands. The RFID labels are pre-programmed, such as by the manufacturer, as will be discussed below. Labels from roll 104 are fed over an RFID antenna 106, programmed or read, and printed by a thermal print head 108. A host computer 112 coupled to a system controller 110 that is in turn coupled to RFID reader subsystem 102, which includes antenna 106, allows the RFID tag on each label to be written to and verified. After interrogation by antenna 106, the label passes through thermal print head 108 for printing. The resulting label then has both a printed media as well as a programmed RFID tag that can be read, such as with bar code scanners and RF readers, respectively.

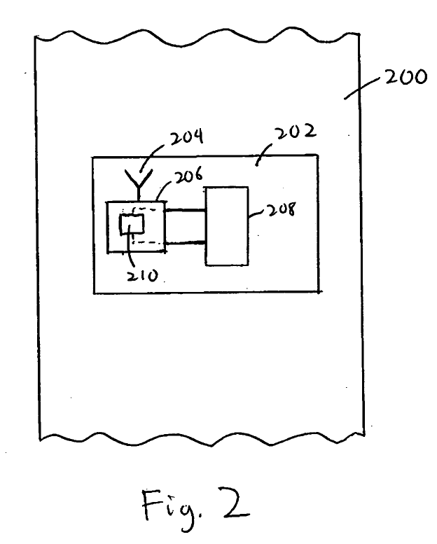

FIG. 2 shows a portion of a label 200 from roll 104 of FIG. 1, where label 200 includes an RFID tag 202, where the size of RFID tag 202 is exaggerated for clarity. RFID tag 202 comprises an antenna 204, a transponder 206 and an optional energy storage device 208, such as a battery or capacitor. RFID tag 202 may be placed at any suitable location within label 20d for interrogation by antenna 106. RFID tag 202, in response to being interrogated, transmits information or data stored in a memory 210, to RFID reader 114 via antenna 106. Memory 210 can be any suitable memory used in conventional RFID tags. RFID tag 202, in one embodiment, is embedded in label 200 between a layer of wax paper or liner and the adhesive side of label 200. Label 200 is one of many labels from roll 104, where each label 200 can be separated from an adjacent label, such as by a perforation. Label 200 shown in FIG. 2 can be various sizes, such as 4×6 inches, 4×2 inches, and 3×3 inches.

Referring back to FIG. 1, labels 200 from roll 104 pass over RFID antenna 106 for interrogation, typically at a high rate of speed. For example, labels 200 pass at a speed of up to 10 inches per second, which for a 6-inch label is up to 5 labels every 3 seconds. A media drive motor 116, coupled to system controller 110, drives a platen 118 to pull labels 200 through the printer, as is known in the art. System controller 110 is also coupled to a power supply 120 and a user-operated control panel 122 that allows the user to control certain operations of the print system, as will be discussed below. System controller 110 also controls thermal ribbon drive motors 124 and receives information from a label position sensor 130, which allows system controller 110 to communicate the appropriate actions to other portions of the printer system, based on information read from the RFID tag. An interface adapter and power supply assembly 128 within RFID reader subsystem 102 provides power to RFID reader 114, which in turn powers RFID antenna 106. Interface adapter and power supply assembly 128 allows signals between system controller 110 and reader 114 to be received and transmitted.

Due in part to the small areas within a printer system, labels 200 are brought in close proximity to RFID antenna 106 during interrogation, e.g., approximately 0.035 inches or less of RFID antenna 106. Thus, contrary to conventional antennas used for RFID tag interrogation having large beam widths, RFID antenna 106 must be capable of interrogating fast moving RFID tags that are in close proximity to each other and to the RFID antenna. Some suitable antennas are described in commonly-owned U.S. patent application Ser. Nos. 10/660,856, 10/863,055, and 10/863,317, all of which are incorporated by reference in their entirety.

According to one embodiment, RFID tag 202 is pre-programmed with information about the tag or label, such as properties, characteristics, size, and type. Because RFID tags provide data storage capability, such as in memory 210, useful information can be retained. Data stored in the tag prior to printing or pre-programmed data can include any information necessary or helpful to improve the efficiency or quality of the printing process. The pre-programmed data can include information such as, but not limited to, the RFID IC vendor source (e.g., Alien Technology, Matrics, or Philips), the RFID IC vendor lot number and/or date code, the RFID inlay performance level (e.g., RF grade level), the RFID inlay antenna type (e.g., Squiggle, M-Tag, or Dual-Dipole), the type of RFID label material (e.g., Fasson 1C pressure sensitive label), the type of RFID label liner (e.g., Fasson super-calendared kraft), the RFID label configuration (e.g., top-of-form identification used, whether die-cut, whether perforated, whether adhesive type), and the RFID label dimensions (e.g., 4″×6″, 3″×3″, or 4″×2″).

This type of information can be programmed by the manufacturer at any time prior to printing optically readable information on the RFID label. For example, the information can be stored either before or after embedding the RFID tag into the label. Conventional programming may be used to write the data into memory 210 of RFID tag 202 embedded in label 200 and is thus not discussed herein.

Once the information is programmed, it can be read by an RFID printer system, such as system 100 of FIG. 1. The pre-programmed tags are contained within labels of roll 104. In some embodiments, not all the tags in the roll are pre-programmed, e.g., only the first one or few of the tags at the beginning of the roll may need to be programmed. As discussed above, RFID labels are moved across RFID antenna 106 for interrogation. Information stored in the tags, such as described above, are read and processed by RFID reader 114 and system controller 110. System controller 110 then configures the printer for optical printing and encoding performance based on information read from the RFID tag.

Some configurations parameters could be (but are not limited to) automatically marking (or over-striking) RFID tags/labels that do not meet certain performance criteria, automatically setting the RF power level for the particular antenna type, automatically setting print head heat settings and print speeds, and verifying that the correct media is loaded for the application program. System controller 110 sends the appropriate signals for configuration, such as to RFID reader 114, print head 108, or control panel 122.

In other embodiments, the data can be used to provide exception-handling conditions which can be fed back to the remote or local printer operator for notification that printer attention is required. Examples of such exceptions include, but are not limited to a warning that the incorrect media is loaded in the printer, and advanced warning of low media conditions.

These exceptions can be sensed through remote management software applications, which in turn transmits the warning or information, such as by email, to appropriate personnel.

Other types of information that can be pre-programmed in the RFID tags allow the quality data to be tracked in the printer. This data includes, but is not limited to tracking RFID quality, tracking RFID inlay quality, and tracking label conversion quality. Note that this information, as before, can be stored on a single or on multiple RFID tags embedded in the media roll core or within each label/tag on the roll, as appropriate for the information provided.

In another embodiment of the invention, the pre-programmed RFID tag can be embedded in a printer ribbon core. In this embodiment, information about the ribbon is read by the system to improve printer performance. As the ribbon passes within range of the RFID antenna, the RFID reader reads the stored information, such as by interrogating the tag. Information may include, e.g., the type of ribbon, the ribbon vendor name or identifier, the ribbon formulation, the ribbon date/lot code, and the ribbon size (e.g., length and width). The RFID reader can then transmit the data to system controller 110 or other device for configuration to increase printer performance. Configuration parameters may include automatically setting print head heat settings and adjusting print speeds.

The information may also be used to provide advanced warning of ribbon low status. For example, the RFID reader can determine, from reading the tag, when a new ribbon roll is loaded. Then, in conjunction with the printer internal capabilities, the amount of ribbon consumed is measured, which allows the system to determine when the ribbon is running low. The RFID tag in the ribbon core may also be written to by the printer system, such as to maintain updated information on the amount of ribbon consumed. This is beneficial if the ribbon is moved to another printer system. The new printer system can then read the information in the RFID tag in the ribbon roll to determine how much ribbon is remaining.

In further embodiments, a pre-programmed RFID tag can be attached to a print head, such as print head 108 of FIG. 1. Information about the print head can be stored in the RFID tag, such as with initialization data in the factor where the print head is manufactured. For example, initialization data could include information about the print head vendor, the model number, the lot code, the date code, the print head resolution, the print width, warranty initialization date, warranty period, expiration date, and data about the print head operation, such as bad pixel detection. This information can then be read by an RFID reader within a printer system using the corresponding print head.

For example, during printing of RFID labels, the RFID reader/encoder can track the amount of media of media run through the print head, which can be encoded or written to the RFID tag. This information can then be compared with pre-programmed information, such as by system controller 110, to determine whether an action or notification is needed. In one instance, this determination can be used to notify the operator or user that the print head needs to be replaced. When the amount of media passed is within a certain range of the suggested usage of the print head, the user may be notified that replacement will be needed soon. In another instance, the printer system compares the current date to the warranty expiration date of the print head. The operator can be sent periodical warnings, such as via the printer control panel menu or to a remote management software application, that the warranty period is about to expire or has expired.

Printer system 100 can be a standard thermal printing system, with the RFID antenna and a reader/encoder installed, for use with the present invention. Other suitable printers may be the T5000 and the SmartLine SL5000 from Printronix of Irvine, Calif.

The above-described embodiments of the present invention are merely meant to be illustrative and not limiting. For example, the description has listed different types of pre-programmed information in an RFID tag and discussed uses for such information in an RFID printer system. However, other pre-programmed information and other uses may also improve RFID printer performance and are within the scope of the present invention. Further, the above description discusses an RFID tag containing information about and attached to an RFID label, a print ribbon, or a print head. However, the RFID tag can also contain information and be attached to other elements used in an RFID printer system. It will thus be obvious to those skilled in the art that various changes and modifications may be made without departing from this invention in its broader aspects. Therefore, the appended claims encompass all such changes and modifications as fall within the true spirit and scope of this invention.

What is claimed is:

1. A radio frequency identification (RFID) tag, comprising:
an antenna for receiving and transmitting RFID signals;
a transponder configured to the antenna for processing signals received from and transmitted to the antenna; and
a memory coupled to the transponder, wherein the memory contains pre-programmed information for use by an RFID printer system.

2. The RFID tag of claim 1, wherein the tag is embedded in a label and wherein the pre-programmed information comprises RFID tag and label information.

3. The RFID tag of claim 2, wherein the RFID tag and label information comprises information about IC vendor source, IC vendor lot number, IC vendor date code, inlay performance level, inlay antenna type, label material, label liner type, label configuration, or label dimensions.

4. The RFID tag of claim 1, wherein the tag is attached to a ribbon for the RFID printer system and wherein the pre-programmed information comprises ribbon information.

5. The RFID tag of claim 4, wherein the ribbon information comprises information about ribbon vendor source, ribbon formulation, ribbon date code, ribbon lot code, or ribbon size.

6. The RFID tag of claim 1, wherein the tag is attached to a print head for the RFID printer system and wherein the pre-programmed information comprises print head information.

7. The RFID tag of Claim 6, wherein the print head information comprises information about print head vendor source, print head model number, print head lot code, print head date code, print head resolution, print head width, print head operation, or warranty of the print head.

8. A Radio Frequency Identification (RFID) printer system, comprising:
an RFID reader;
a system controller adapted to communicate with the RFID reader; and
a roll of RFID labels capable of being read by the RFID reader, wherein at least one of the RFID labels contains an RFID tag, and wherein the RFID tag contains pre-programmed information about the RFID tag and the label.

9. The RFID printer system of claim 8, wherein the system controller configures printing parameters based on the pre-programmed information.

10. The RFID printer system of claim 8, wherein the system controller provides notifications based on the pre-programmed information.

11. A Radio Frequency Identification (RFID) printer system, comprising:
an RFID reader;
a system controller adapted to communicate with the RFID reader; and
a print ribbon containing an RFID tag, wherein the RFID tag contains pre-programmed information about the print ribbon and wherein the RFID tag is capable of being read and written to by the RFID reader.

12. The RFID printer system of claim 11, wherein the system controller configures printing parameters based on the pre-programmed information.

13. The RFID printer system of claim 11, wherein the system controller provides notifications based on the pre-programmed information.

14. A Radio Frequency Identification (RFID) printer system, comprising:
an RFID reader;
a system controller adapted to communicate with the RFID reader; and
a print head having an RFID tag, wherein the RFID tag contains pre-programmed information about the print head and wherein the RFID tag is capable of being read and written to by the RFID reader.

15. The RFID printer system of claim 14, wherein the system controller configures printing parameters based on the pre-programmed information.

16. The RFID printer system of claim 14, wherein the system controller provides notifications based on the pre-programmed information.

17. A method of operating an RFID printer system having a roll of RFID labels, a print head, and a print ribbon, the method comprising:
reading pre-programmed information from an RFID tag; and
adjusting the printer system based on the pre-programmed information.

18. The method of claim 17, wherein the RFID tag is contained within at least one label in the roll of RFID labels.

19. The method of claim 18, wherein the pre-programmed information is information about the RFID labels or RFID tag.

20. The method of claim 17, wherein the RFID tag is attached to the print head.

21. The method of claim 20, wherein the pre-programmed information is information about the print head.

22. The method of claim 17, wherein the RFID tag is attached to the print ribbon.

23. The method of claim 22, wherein the pre-programmed information is information about the print ribbon.

24. A method of manufacturing an RFID tag, comprising:
providing an RFID tag with a memory; and
programming information into the memory before using the RFID tag in an RFID printer system.

25. The method of claim 24, wherein the programming comprises programming information about the RFID tag or an RFID label.

26. The method of claim 24, wherein the programming comprises programming information about a print head for use in the RFID printer system.

27. The method of claim 24, wherein programming comprises programming information about a print ribbon for use in the RFID printer system.
